(19) United States
(12) Patent Application Publication
(10) Pub. No.: US 2014/0253726 A1
(43) Pub. Date: Sep. 11, 2014

(54) SYSTEM, APPARATUS, AND METHOD FOR PREDICTING ANIMAL ACTIVITY OR INACTIVITY

(71) Applicant: Curtis Stokes Koontz, Signal Mountain, TN (US)

(72) Inventor: Curtis Stokes Koontz, Signal Mountain, TN (US)

(21) Appl. No.: 13/792,924

(22) Filed: Mar. 11, 2013

(51) Int. Cl. G06K 9/62

(52) U.S. Cl. CPC G06K 9/6293
USPC 348/143; 382/228

(57) ABSTRACT

A system for predicting animal activity is disclosed. The system comprises an imaging device to capture an image of a predetermined area and an environmental data sensor to detect one or more environmental factors within the predetermined area. The environmental data sensor collects random environmental data at least once during a predetermined period. A trigger is in signal communication with the imaging device and the environmental data sensor. When the trigger is activated, the imaging device captures the image and the environmental data sensor collects triggered environmental data. The trigger is responsive to the presence of wildlife. A storage unit stores the random environmental data, the image, and the triggered environmental data. The random environmental data and the triggered environmental data are provided to a statistical regression to determine a statistical probability algorithm. The statistical probability algorithm calculates a predicted activity index for wildlife in the predetermined area.

### BACKGROUND

Many hunters and fisherman have limited time available for engaging in their chosen activities. Much of the time spent in the field is spent waiting for wildlife to enter a hunter's chosen hunting area, such as an area that can be seen from a hunting blind or a specific fishing area. Modern trail cameras can be used to observe chosen hunting or fishing areas to determine when wildlife is in the designated area.

Modern trail cameras are only triggered when wildlife is currently in the observed area. However, information about wildlife in a specific area at the present time may not provide a hunter with enough notice, as many hunters do not live close enough to their chosen hunting area to immediately respond to current wildlife activity. Trail cameras fail to provide hunters with information about future activity of wildlife. What is needed is a system for predicting when wildlife will be in a specific area such that hunters and fisherman can plan their hunting trips accordingly.

### SUMMARY

In various embodiments, a system for predicting animal activity is disclosed. The system comprises an imaging device configured to capture an image of a predetermined area and an environmental data sensor configured to detect one or more environmental factors within the predetermined area. The environmental data sensor is configured to collect random environmental data at least once during a predetermined period. A trigger is in signal communication with the imaging device and the environmental data sensor. When the trigger is activated, the imaging device captures the image of the predetermined area and the environmental data sensor collects triggered environmental data. The trigger is responsive to the presence of wildlife within the predetermined area. A storage unit is configured to store the random environmental data, the image of the predetermined area, and the triggered environmental data. The random environmental data and the triggered environmental data are provided to a statistical regression to determine a statistical probability algorithm. The statistical probability algorithm calculates a predicted activity index for wildlife in the predetermined area.

In various embodiments, a method for predicting animal activity is disclosed. The method comprises receiving, by a processor, random environmental data. The random environmental data comprises at least one environmental factor measured within a predetermined area. The method further comprises receiving, by the processor, triggered environmental data. The processor implements a statistical regression to determine a statistical probability algorithm. The statistical probability algorithm calculates a predicted activity index for the predetermined area. The random environmental data and the triggered environmental data are provided as inputs to the statistical regression.

In various embodiments, a computer is configured to calculate a predicted activity index of wildlife within a predetermined area. The computer comprises a processor and a memory unit. The memory unit is configured to store a plurality of instruction. The plurality of instructions is loaded by the processor and configures the processor to receive random environmental data and triggered environmental data. The random environmental data and the triggered environmental data comprise at least one environmental factor. The processor is further configured to determine a statistical probability algorithm using a statistical regression. The random environmental data and the triggered environmental data are provided to the statistical regression. The processor receives user environmental data. The user environmental data comprises the at least one environmental factor. The processor calculates the predicted activity index of wildlife based on the user environmental data and the statistical probability algorithm.

### DRAWINGS

The features of the various embodiments are set forth with particularity in the appended claims. The various embodiments, however, both as to organization and methods of operation, together with advantages thereof, may best be understood by reference to the following description, taken in conjunction with the accompanying drawings as follows:

FIG. 1 illustrates one embodiment of a system for predicting animal activity within a predetermined area.

FIG. 2 illustrates one embodiment of a system for collecting random and triggered environmental data.

FIG. 3 illustrates one embodiment of an environmental camera configured to collect data for predicting animal activity within a predetermined area.

FIG. 4 illustrates one embodiment of a server configured to implement a statistical probability algorithm.

FIG. 5 illustrates one embodiment of a computer system configured to access a predicted activity index.

FIG. 6 illustrates one embodiment of a mobile device configured to access a predicted activity index.

FIGS. 7 and 8 illustrate various embodiments of images captured by the environmental camera in conjunction with the triggered environmental data.

FIG. 9 illustrates one embodiment of a computing environment for implementing a statistical probability algorithm.

### DETAILED DESCRIPTION

In various embodiments, a system for predicting animal activity is disclosed. The system comprises an imaging device configured to capture an image of a predetermined area and an environmental data sensor configured to detect one or more environmental factors within the predetermined area. The environmental data sensor is configured to collect random environmental data at least once during a predetermined period. A trigger is in signal communication with the imaging device and the environmental data sensor. When the trigger is activated, the imaging device captures the image of the predetermined area and the environmental data sensor collects triggered environmental data. The trigger is responsive to the presence of wildlife within the predetermined area. A storage unit is configured to store the random environmental data, the image of the predetermined area, and the triggered environmental data. The random environmental data and the triggered environmental data are provided to a statistical regression to determine a statistical probability algorithm. The statistical probability algorithm calculates a predicted activity index for wildlife in the predetermined area.

In various embodiments, a method for predicting animal activity is disclosed. The method comprises receiving, by a processor, random environmental data. The random environmental data comprises at least one environmental factor measured within a predetermined area. The method further comprises receiving, by the processor, triggered environmental data. The processor implements a statistical regression to determine a statistical probability algorithm. The statistical probability algorithm calculates a predicted activity index for the predetermined area. The random environmental data and the triggered environmental data are provided as inputs to the statistical regression.

In various embodiments, a computer is configured to calculate a predicted activity index of wildlife within a predetermined area. The computer comprises a processor and a memory unit. The memory unit is configured to store a plurality of instruction. The plurality of instructions is loaded by the processor and configures the processor to receive random environmental data and triggered environmental data. The random environmental data and the triggered environmental data comprise at least one environmental factor. The processor is further configured to determine a statistical probability algorithm using a statistical regression. The random environmental data and the triggered environmental data are provided to the statistical regression. The processor receives user environmental data. The user environmental data comprises the at least one environmental factor. The processor calculates the predicted activity index of wildlife based on the user environmental data and the statistical probability algorithm.

Reference will now be made in detail to several embodiments, including embodiments showing example implementations of systems for predicting animal activity within a predetermined area. Wherever practicable similar or like reference numbers may be used in the figures and may indicate similar or like functionality. The figures depict example embodiments of the disclosed systems and/or methods of use for purposes of illustration only. One skilled in the art will readily recognize from the following description that alternative example embodiments of the structures and methods illustrated herein may be employed without departing from the principles described herein.

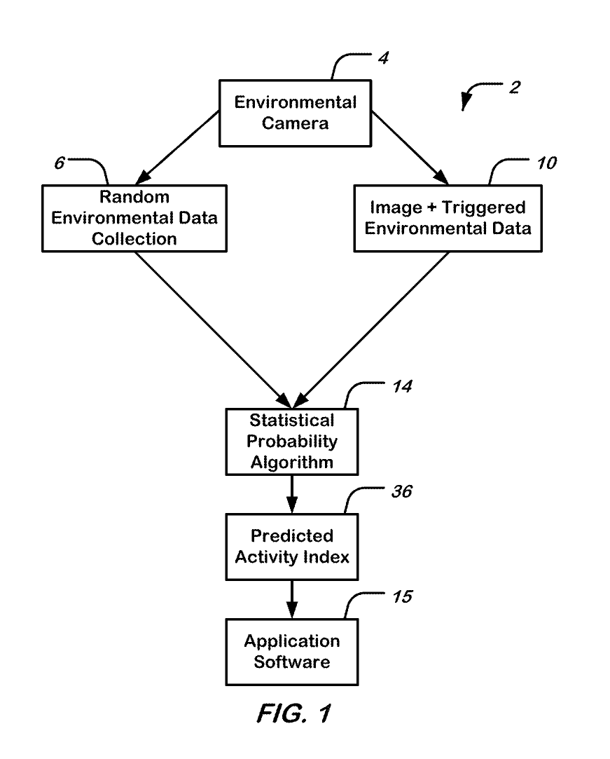

FIG. 1 illustrates one embodiment of a system 2 for predicting animal activity within a predetermined area. An environmental camera 4 may be positioned within a predetermined area. The predetermined area may be any area in which a user wishes to monitor and predict wildlife activity. For example, the predetermined area may be the location of a hunting blind, a specific area of a lake, or any other area that may be monitored for animal activity. Although the embodiments of the present disclosure are generally discussed with reference to a hunter or hunting area, those skilled in the art will recognize that the systems and methods disclosed herein may be used for any form of tracking and predicting wildlife presence within a predetermined area. For example, the system 2 for predicting animal activity may be used to predict the presence fish within a designated portion of a body of water, to predict the movements of wildlife for the purpose of studying, tracking, or tagging, to predict the presence of wildlife and initiate counter-poaching operations within the designated area, or any purpose related to predicting animal activity within a predetermined area.

The environmental camera 4 may be configured to collect random environmental data 6 and triggered environmental data 10. The random environmental data 6 may comprise any measurable environmental factors, such as, for example temperature, wind speed, wind direction, dew point, humidity, barometric pressure, and any other suitable environmental factor. The environmental camera 4 may be further configured to collect temporal environmental factors such as, for example, date, time, lunar phase, etc. The environmental camera 4 may be configured to collect random environmental data 6 at least once during a predetermined interval. For example, the environmental camera 4 may be configured to collect random environmental data 6 at least once an hour while the environmental camera 4 is active. In some embodiments, the environmental camera 4 may collect the random environmental data 6 periodically, such as, for example, once every hour.

The environmental camera 4 may be configured to collect triggered environmental data 10. The triggered environmental data 10 may comprise the same environmental factors as the random environmental data 6. The environmental camera 4 may collect the triggered environmental data 10 when triggered by a specific event, such as, for example, the presence of wildlife within the predetermined area monitored by the environmental camera 4. The environmental camera 4 may be configured to capture an image of the predetermined area concurrently with the collection of triggered environmental data 10. In some embodiments, the random environmental data 6 and the triggered environmental data 10 may be stored in a memory unit included in the environmental camera 4.

The random environmental data 6 and the triggered environmental data 10 may be used to determine a statistical probability algorithm 14. The statistical probability algorithm 14 may be configured to determine a predicted activity index 36 for animal activity within the predetermined area. The statistical probability algorithm 14 may be determined by comparing the random environmental data 6 and the triggered environmental data 10, such as, for example, in a statistical regression, to determine the environmental factors that most closely correlate with the presence of wildlife within the predetermined area. The statistical probability algorithm 14 may be modified based on additional random environmental data 6 and additional triggered environmental data 10 observed by environmental camera 4. The statistical model 14 may be configured to determine a predicted activity index 36 corresponding to the presence of wildlife based on specific environmental factors in the predetermined area. For example, in one embodiment, the environmental camera 4 may collect random environmental data 6 at least once an hour for seven days. During that seven day period, the environmental camera 4 may be triggered five times to collect triggered environmental data 10 by wildlife in the predetermined area. The environmental camera 4 may provide the random environmental data 6 and the triggered environmental data 10 to a statistical regression to determine a statistical probability algorithm 14. The statistical regression may determine that the each of the environmental factors of the triggered environmental data 10 falls within a specific range. The statistical probability algorithm 14 may assign weighting factors to each of the environmental factors based on the specific range of the environmental factor within the triggered environmental data 10 as compared to the random environmental data 6. The statistical probability algorithm 14 may be used to calculate the predicted activity index 36 which may be used to predict the presence of wildlife within the predetermined area based on a set of environmental factors observed by the environmental camera 4 or entered by a user.

The statistical probability algorithm 14 may be determined using any suitable statistical regression model. For example, in various embodiments, the statistical probability algorithm 14 may be determined by a linear regression model, a nonlinear regression model, a multivariate regression model, or any other suitable regression model. The statistical probability algorithm 14 may be a fixed model or may be modified based on the random environmental data 6 and the triggered environmental data 10 received by the statistical regression. In some embodiments, the statistical probability algorithm may calculate a predictive activity index (PAI) of the form

PAI=Xa+Yb+Zc . . .

wherein X, Y, and Z comprise the environmental factors collected by the environmental camera 4 during the random environmental data 6 and the triggered environmental data 10 collection. The coefficients a, b, and c are calculated using the statistical probability algorithm 14 and assign weighting factors to each of the environmental factors X, Y, and Z. The coefficients a, b, and c may be updated as additional random environmental data 6 and triggered environmental data 10 is provided to the statistical probability algorithm 14.

In some embodiments, the statistical probability algorithm 14 may be determined through a statistical regression model. The statistical regression model may be directed towards modeling and analyzing several variables to determine the relationship between a dependent variable and one or more independent variables. The statistical regression model may determine the conditional expectation of a dependent variable given one or more independent variables or may determine a quantile or other location parameter of the conditional distribution of the dependent variable given the independent variables. In some embodiments, the variation of the dependent variable around the regression function may be characterized ad may described by a probability distribution, such as the statistical probability algorithm 14. The statistical regression model may comprise, for example, a linear regression, a least square regression, or any other parametric regression. In some embodiments, the statistical regression model may comprise a non-parametric regression. In some embodiments, a larger sample of data, such as, for example, a greater number of random environmental data 6 or triggered environmental data 10, may increase the accuracy of the statistical regression model.

In some embodiments, the statistical probability algorithm may be determined by a linear regression model. In a linear regression model, data may be modeled by one or more linear predictor functions. Unknown parameters of the model, such as, for example, weighting factors for each of the environmental factors, may be estimated using the input data and the linear predictor functions. In some embodiments, a linear regression may comprise a model in which the conditional mean of a value y given a value X is expressed as a linear function of X. The linear regression model may determine the conditional probability distribution of y given X. A linear regression model may be used to determine a statistical probability algorithm. The linear regression may fit a predictive model to an observed data set of a plurality of y and X values. Once a fit has been found, additional values of X may be provided to the linear regression model to make a prediction of the value y for the addition value X. In some embodiments, given a variable y and a number of variables X₁ . . . Xₚ that may be related to y, a linear regression analysis may be applied to quantify the strength of the relationship between y and X₁ . . . Xₚ to determine which Xᵢ (wherein i is a value between 1 and p) may have no relationship with y or may contain redundant information about y.

In some embodiments, a user may access the statistical probability algorithm 14, the predicted activity index 36, the collected random environmental data 6, or the triggered environmental data 10 through one or more user applications 16. For example, a user may access the statistical probability algorithm 14 using a user application 16 running on a desktop computing device or a mobile computing device.

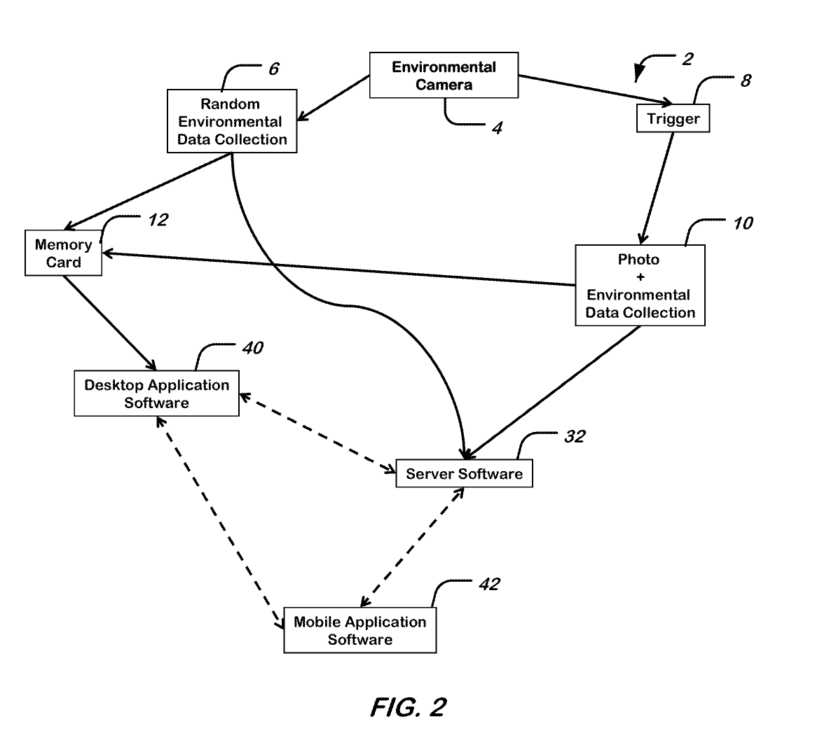

FIG. 2 illustrates one embodiment of a system for gathering environmental data for calculating a predicted activity index 36. An environmental camera 4 may be configured to monitor a predetermined area. The environmental camera 4 may collect random environmental data 6. The random environmental data 6 may be collected from the predetermined area at random intervals. In some embodiments, the random environmental data 6 may be collected periodically. The environmental camera 4 may be configured to collect triggered environmental data 10. The triggered environmental data 10 may be collected when a trigger 8 is activated. The trigger 8 may be any suitable trigger for detecting the presence of wildlife within the predetermined area, such as, for example, a motion sensor, a pressure sensor, an infrared sensor, or any other suitable sensor. The environmental camera 4 may collect the triggered environmental data 10 when wildlife is detected within the predetermined area. In some embodiments, the environmental camera may capture an image of the predetermined area in response to the trigger 8. The random environmental data 6, the triggered environmental data 10, and the captured images may be stored in a memory unit coupled to the environmental camera 4. The memory unit may comprise a removable memory card 12.

The random environmental data 6 and the triggered environmental data 10 may be provided to a server 32. The server 32 may be configured to implement the statistical regression to determine a statistical probability algorithm 14. The server 32 may calculate the predicted activity index 36 for the predetermined area monitored by the environmental camera 4. In some embodiments, the memory card 12 may be transferred to a desktop computing environment configured with the desktop application software 40. The desktop application software 40 may be in communication with the server 32 and may be configured to provide the random environmental data 6, the triggered environmental data 10, and the captured images stored on the memory card 12 to the server 32. A mobile device configured to execute mobile application software 42 may be in communication with the server 32 and the desktop application software 40.

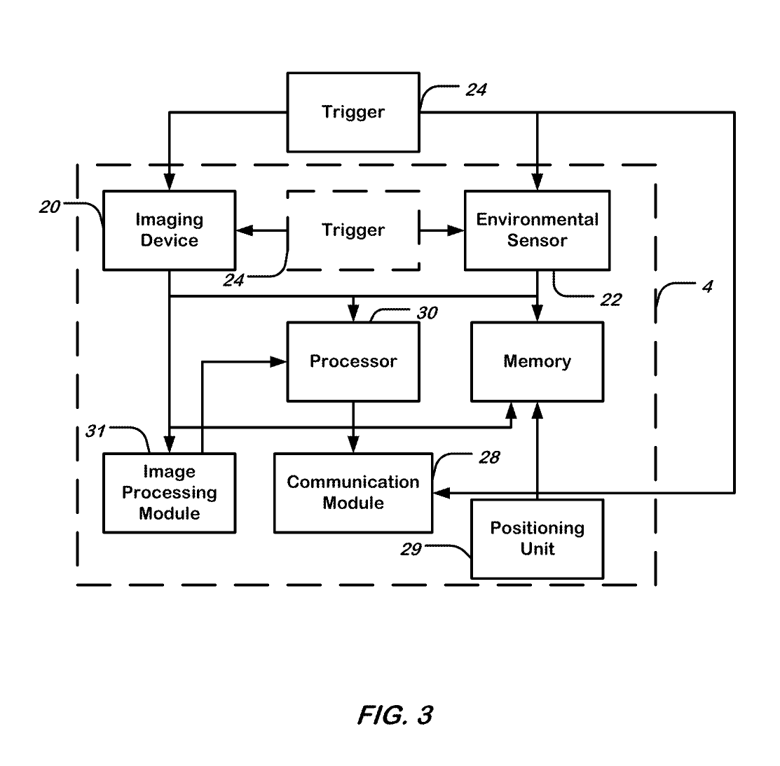

FIG. 3 illustrates one embodiment of an environmental camera 4. In some embodiments, the environmental camera 4 may comprise an imaging device 20 and an environmental sensor 22. The imaging device 20 may be configured to capture an image of the predetermined area. In various embodiments, the imaging device 20 may be any suitable imaging device, such as, for example, a charge-coupled device (CCD) or a complimentary metal-oxide semiconductor (CMOS) device.

In some embodiments, the environmental camera 4 may comprise an environmental sensor 22. The environmental sensor 22 may be configured to detect one or more environmental factors, such as, for example, temperature, wind speed, wind direction, dew point, humidity, barometric pressure, or any other environmental factor. The environmental sensor 22 may comprise a single sensor or multiple sensors configured to detect the one or more environmental factors. In some embodiments, the environmental sensor 22 may be configured to record temporal environmental factors such as, for example, the month, day, or time of the data collection.

The environmental sensor 22 may be configured to collect random environmental data 6. The random environmental data 6 provides a comparison for the triggered environmental data 10 in the statistical probability algorithm. In some embodiments, the environmental sensor 22 may be configured to collect random environmental data 6 at least once during a predetermined interval. For example, the environmental sensor 22 may be configured to collect random environmental data 6 at least once every hour. In some embodiments, the environmental sensor 22 may be configured to collect random environmental data 6 periodically, such as, for example, once every hour.

In some embodiments, the environmental camera 4 may be in signal communication with a trigger 24. The trigger 24 may be configured to detect the presence of wildlife within the predetermined area monitored by the environmental camera 4. For example, the trigger 24 may comprise any suitable device for activating the environmental camera 4 when wildlife is within a field of view of the imaging device, such as, for example, a motion sensor, a pressure sensor, or an infrared sensor, to name just a few. The trigger 24 may be formed integrally with the environmental camera 4 or may be located remotely from the environmental camera 4. The trigger 24 may be in signal communication with the environmental camera 4 through any suitable means, such as, for example, wired or wireless communication.

In some embodiments, the trigger 24 is in signal communication with the environmental sensor 22. The trigger 24 may be configured to control the operation of the environmental sensor 22. When the trigger 24 is activated, such as by wildlife in the predetermined area monitored by the environmental camera 4, the environmental sensor 22 may be activated to collect triggered environmental data 10. The triggered environmental data 10 may comprise the same environmental factors as the random environmental data 6 collected by the environmental camera 4. The triggered environmental data 10 may be used to determine the statistical probability algorithm 14 and to calculate the predicted activity index 36 for the predetermined area.

In some embodiments, the trigger 24 may be in signal communication with the imaging device 20. When the trigger 24 is activated, the imaging device 20 may capture an image of the predetermined area. The image of the predetermined area may show the type of wildlife that activated the trigger. The image may also show the activity that the wildlife was engaged in when the trigger 24 was activated, such as, for example, feeding, migrating, or marking.

The environmental camera 4 may comprise a memory unit 26. The memory unit 26 may be configured to store the random environmental data 6, the triggered environmental data 10, and images captured by the imaging device 20. The memory unit 26 may be in signal communication with the imaging device 20 and the environmental sensor 22. In some embodiments, the memory unit 26 may be removable. For example, in some embodiments, the memory unit 26 may comprise a memory card 12, such as a flash drive, configured to store environmental data and images collected by the environmental camera 4. In some embodiments, the memory unit 26 may be in signal communication with a wireless communication module 28. The wireless communication module 28 may be configured to transmit the random environmental data 6, the triggered environmental data 10, and the images captured by the imaging device 20 to a remote device. The wireless communication module 28 may be configured to communicate with the remote device using any suitable wireless communication protocol, such as, for example, Wi-Fi, LTE, GSM, CDMA, or any other suitable wireless communication protocol.

The environmental camera 4 may comprise a processor 30. The processor 30 may be configured to control one or more operations of the environmental camera 4, such as, for example, controlling the imaging device 20 and the environmental sensor 22 in response to the trigger 24. In some embodiments, the processor 30 may be configured to determine the statistical probability algorithm 14 and to calculate the predicted activity index 36. The processor 30 may be configured to receive the random environmental data 6 and the triggered environmental data 10 from the memory unit 26. The processor 30 may use any suitable regression model, such as, for example, a linear regression, to determine the statistical probability algorithm 14. The processor 30 may use the statistical probability algorithm 14 to calculate a predicted activity index 36. The statistical probability algorithm 14 and the predicted activity index 36 may be stored in the memory unit 26 or transmitted to a remote device by the wireless communication module 28.

The environmental camera 4 may be configured to perform image processing on the captured images. In some embodiments, the processor 30 may be configured with an image processing module. In some embodiments, a stand-alone image processing module 31 may be incorporated in the environmental camera 4. The image processing module 31 may be configured to receive the captured images from the imaging device 20. The image processing module 31 may process the images to determine the presence of wildlife within the captured image. In some embodiments, the image processing module 31 may be configured to detect a specific type of wildlife. For example, in some embodiments, a hunter may be interested in predicting the presence of only white-tail dear within a predetermined area. The image processing module 31 may be configured to process the captured images and detect the presence of white-tail deer. In some embodiments, the triggered environmental data 10 associated with the captured image may only be stored if the image processing module 31 detects the presence of the specific type of wildlife within the captured image. In some embodiments, the environmental camera 4 may store multiple sets of triggered environmental data 10, with each set corresponding to a specific type of wildlife within the predetermined area.

In some embodiments, the environmental camera 4 may comprise a positioning unit 29. The positioning unit 29 may be configured to obtain position data corresponding to the current position of the environmental camera 4. The positioning unit 29 may be any suitable positioning device, such as, for example, a Global Positioning System (GPS) device. The positioning unit 29 may determine the position of the environmental camera 4 during data collection, such as, for example, when the environmental sensor 22 collects random environmental data 6, triggered environmental data 10, or when the imaging device 20 captures an image of the predetermined area. The positioning unit 29 may be configured to associate the position data collected with the random environmental data 6, the triggered environmental data 10, and the captured images. The positioning data may be stored in the memory unit 26 or may be transmitted to a remote device when the random environmental data 6, the triggered environmental data 10, and the captured images are transmitted to the remote device.

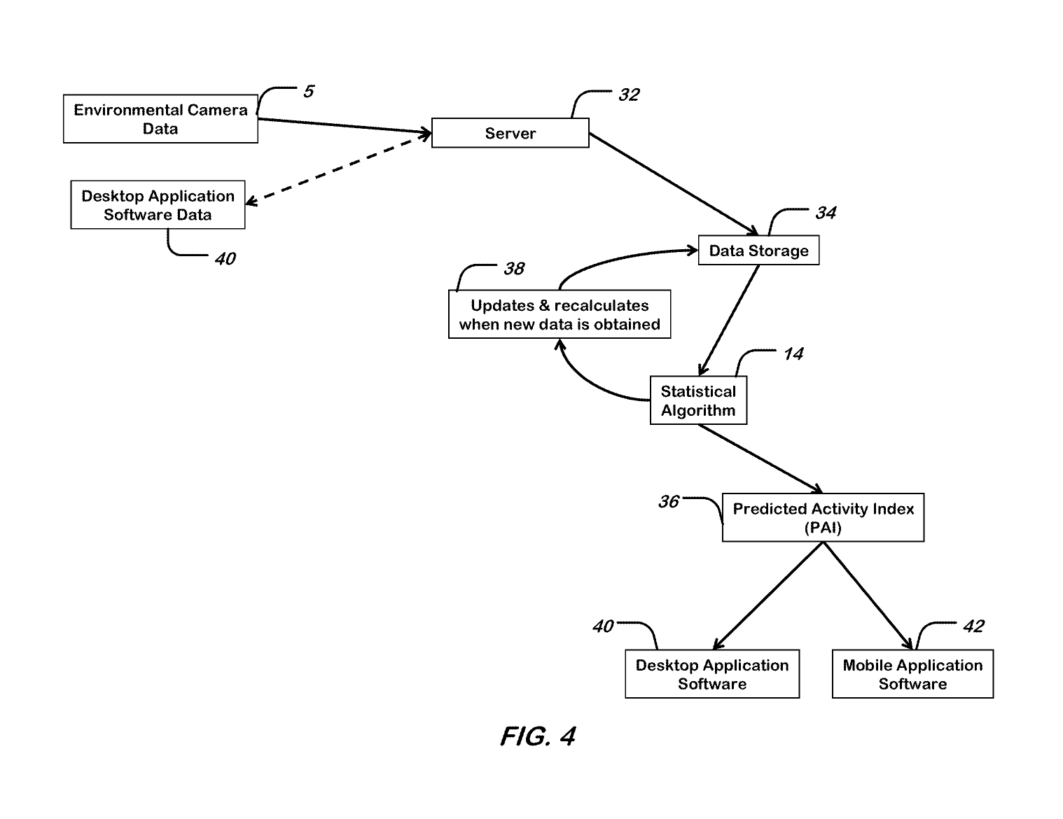

FIG. 4 illustrates one embodiment of a server 32 configured to execute the statistical probability algorithm 14 to calculate the predicted activity index 36. The server 32 may comprise a computer configured to execute one or more services to serve the needs of one or more user devices. The user devices may connect to the server 32 through any suitable connection, such as, for example, a network connection, such as a connection over a local-area network (LAN), a wide-area network (WAN), or an internet connection. The server 32 may comprise any suitable server for providing services to one or more remote devices, such as, for example, a web server, a proxy server, an FTP server, an application server, a database server, a file server, or any other suitable server architecture. The server 32 may be in signal communication with the environmental camera 4 through the wireless communication module 28. The server 32 may be any suitable computing environment for executing the statistical probability algorithm 14. The server 32 may receive environmental camera data 5, such as, for example, the random environmental data 6 and the triggered environmental data 10 from the environmental camera 4. In some embodiments, the server 32 may be configured to receive random environmental data 6 and triggered environmental data 10 from additional sources, such as, for example, the desktop application software 40, the mobile application software 42, a weather service, or any other suitable data source. The server 32 may comprise a memory unit 34 configured to store the received random environmental data 6 and the received triggered environmental data 10. The server 32 may comprise a processor for determining the statistical probability algorithm 14. The statistical probability algorithm 14 may determine a predicted activity index 36. The statistical probability algorithm 14 may be updated 38 as additional random environmental data 6 and triggered environmental data 10 is received from the environmental camera 4.

The server 32 may allow a user to access the statistical probability algorithm 14 or the predicted activity index 36 from a user application 16, such as the desktop application software 40 or the mobile application software 42. A user may access the predicted activity index 36 to predict the optimal environmental factors for the presence of wildlife within the predetermined area. In one embodiment, the server 32 may be configured to determine an optimal set of environmental factors corresponding to the best prediction for the presence of wildlife within the predetermined area and provide the optimal set of environmental factors to a user. In some embodiments, the server 32 may be configured to receive a set of environmental factors from the user and determine the predicted activity index 36 for the provided set of environmental factors. For example, a user may plan a hunting trip to the predetermined area for a specific weekend. The user may obtain a set of environmental factors for the predetermined area during the specific weekend from a weather service. The user may provide the set of environmental factors to the server 32. The server 32 may calculate the predicted activity index 36 for the predetermined area based on the provided set of environmental factors. The user may adjust their hunting plans based on the predicted activity index 36 to maximize their likelihood of success during the hunting trip.

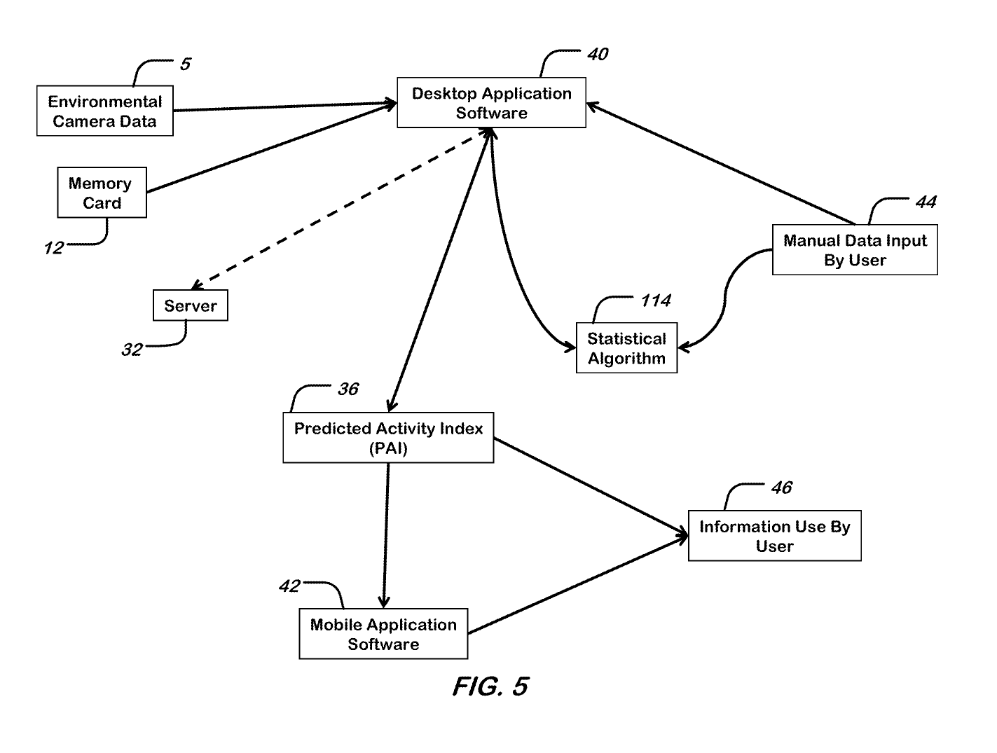

FIG. 5 illustrates one embodiment of a desktop application software 40 configured to provide a predicted activity index 36. In some embodiments, the desktop application software 40 may be configured to receive environmental camera data 5, such as the random environmental data 6 and triggered environmental data 10 from the environmental camera 4. In some embodiments, the random environmental data 6 and the triggered environmental data 10 may be transferred to the desktop application software 40 through a memory card 12. The environmental camera 4 may be configured to receive the memory card 12 and store the random environmental data 6, triggered environmental data 10, and captured images on the memory card 12. The memory card 12 may be removed by a user and coupled to the desktop application software 40, which may access the stored information. In some embodiments, the environmental camera 4 may transmit the random environmental data 6, triggered environmental data 10, and captured images directly to the desktop application software 40, such as, for example, using a wireless communication module 28. The desktop application software 40 may be in communication with the server 32 illustrated in FIG. 4. The desktop application software 40 may use any suitable communication protocol for communicating with the server 32. For example, in some embodiments, the desktop application software 40 may communicate with the server 32 through a Local Area Network (LAN), a Wide Area Network (WAN), the Internet, or any other suitable wired or wireless communication protocol. The desktop application software 40 may be configured to transfer or receive random environmental data 6, triggered environmental data 10, and captured images to and from the server 32.

In some embodiments, the desktop application software 40 may be configured to determine a statistical probability algorithm 114 and to calculate the predicted activity index 36. The desktop application software 40 may use random environmental data 6 and triggered environmental data 10 received from the environmental camera 4 to determine the statistical probability algorithm 14. In some embodiments, the desktop application software 40 may be configured to receive manual data 44 input by a user. For example, in some embodiments, a user may take manual readings of environmental data. A user may take random environmental data 6 measurements while waiting for wildlife to appear and may record triggered environmental data 10 at a time when the user observes wildlife in the predetermined area. The desktop application software 40 may use the manually entered environmental data 44 to determine a statistical probability algorithm 114. In some embodiments, the desktop application software 40 may receive a statistical probability algorithm 114 from the server 32.

The desktop application software 40 may receive future environmental factors from a user and calculate the predicted activity index 36 for the provided future environmental factors. A user may use 46 the predicted activity index 36 to plan trips to the predetermined area. In some embodiments, the desktop application software 40 may access a predictive activity index 36 for multiple areas. The multiple predictive activity indexes 36 may be determined using data from environmental cameras 4 or manual user data 44 located in various predetermined areas. The user computer environment 40 may determine the predetermined area most likely to have wildlife activity based on future environmental factors provided by the user. A user may select 46 a predetermined area for a hunting trip based on the highest predicted activity index 36. The desktop application software 40 may be in communication with mobile application software 42.

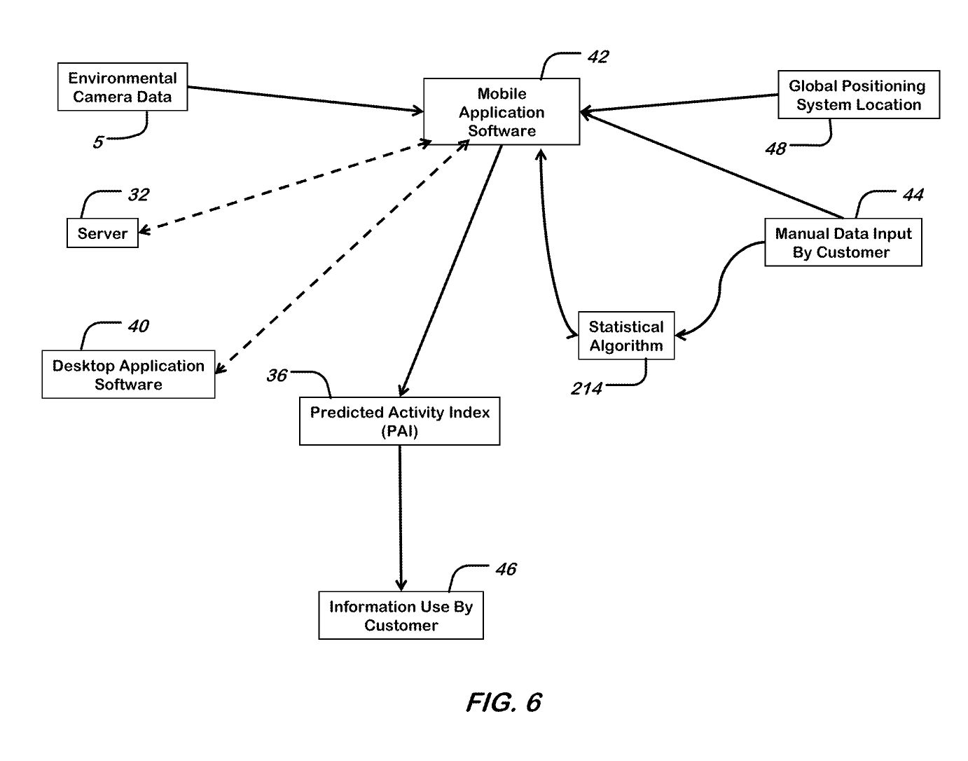

The mobile application software 42, as shown in FIG. 6, may be in communication with the environmental camera 4. The mobile application software 42 may receive environmental camera data 5, such as random environmental data 6, triggered environmental data 10, and captured images, directly from the environmental camera 4 using any suitable communication protocol, such as, for example, a cellular communication protocol. The mobile application software 42 may determine a statistical probability algorithm 214 to calculate a predicted activity index 36 for a predetermined area monitored by the environmental camera 4. In some embodiments, the mobile application software 42 may be configured to receive manual environmental data 44 from a user. For example, in some embodiments, a user may take manual readings of environmental factors. A user may take random environmental data 6 measurements while waiting for wildlife to appear and may record triggered environmental data 10 measurements at a time when the user observes wildlife in the predetermined area. The mobile application software 42 may use the manually entered environmental data to determine a statistical probability algorithm 14.

In some embodiments, the mobile application software 42 may be in communication with the server 32 and the desktop application software 40. The mobile application software 42 may be configured to receive random environmental data 6, triggered environmental data 10, and captured images from the environmental camera 4 and may transmit the received random environmental data 6, triggered environmental data 10, or captured images to the server 32 or the desktop application software 40. The mobile application software 42 may be further configured to transmit manually entered environmental data 44 to the server 32 or the desktop application software 40. The random environmental data 6 and the triggered environmental data 10, whether automatically gathered or manually entered, may be used by the server 32 to determine a statistical probability algorithm 14 for a predetermined area. In some embodiments, the mobile application software 42 may receive a predetermined statistical probability algorithm 214 or a predicted activity index 36 from the server 32. The mobile application software 42 may receive future environmental factors from a user and calculate the predicted activity index 36 for the provided future environmental factors. A user may use 46 the predicted activity index 36 to plan trips to the predetermined area. In some embodiments, the mobile application software 42 may access statistical probability algorithms 214 or predictive activity indexes 36 for multiple areas. The multiple statistic probability models 14 and predictive activity indexes 36 may be determined using data from environmental cameras 4 or manual user data 44 located in various predetermined areas. The mobile application software 42 may determine the predetermined area most likely to have wildlife activity based on the provided future environmental factors. A user may select 46 a predetermined area for a hunting trip based on the highest predicted activity index 36.

In some embodiments, the mobile application software 42 may receive position data 48 corresponding to the current position of the mobile computing device. The position data 48 may comprise any suitable location data, such as, for example, Global Positioning Service (GPS) data. In some embodiments, the user may enter selected positioning data corresponding to a location remote from the mobile application software 42. The mobile application software 42 may use the position data 48 to access a local statistical probability algorithm 14 from the server 32 or the desktop application software 40. For example, in one embodiment, the mobile application software 42 may determine its current location based on the position data 48. The mobile application software 42 may send a request to the server 32 requesting a statistical probability algorithm 14 and may include the position data 48 with the request. The server 32 may check the stored statistical probability algorithms 14 to find a statistical probability algorithm 214 for a predetermined area corresponding to the location data 48. In some embodiments, the server 32 may select the predetermined area closest to the position data 48. In some embodiments, the server 32 may select a plurality of predetermined areas closest to the position data 48. In some embodiments, the server 32 may use position data from the positioning unit 29 to match the statistical probability algorithm 214 with the current or selected position of the mobile application software 42. The server 32 may return the statistical probability algorithm 14 or the predicted activity index 36 for the selected predetermined area. The user may access the received statistical probability algorithm 214 corresponding to the received position data.

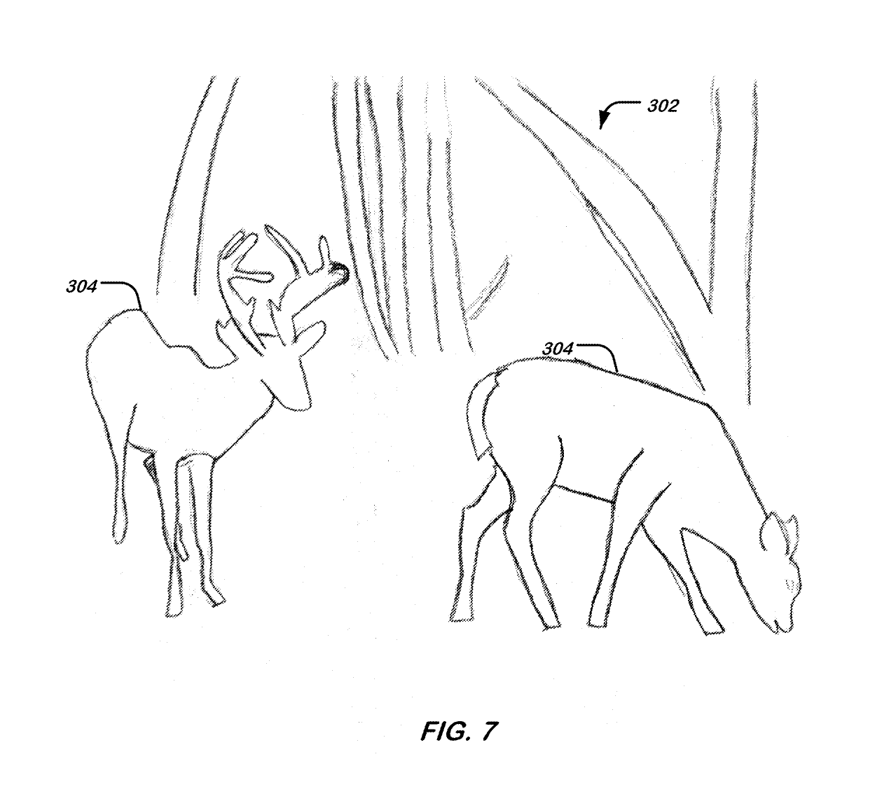

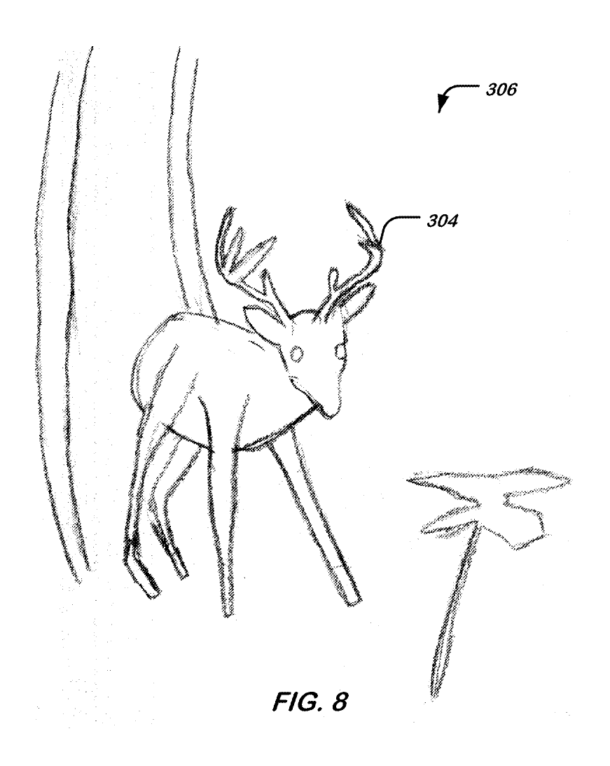

FIGS. 7 and 8 illustrate examples of images captured by an imaging device 20 incorporated into the environmental camera 4. The first image 302 shows wildlife 304 feeding within the predetermined area. The imaging device 20 has been triggered by the presence of the wildlife 304 within the field of view of the imaging device 20. The second image 306 illustrates wildlife 304 moving through the predetermined area. The wildlife 304 may trigger the imaging device 20 and the environmental sensor 22. In some embodiments, the first image 302 and the second image 304 may be processed by an image processing module 31 to determine the presence of a specific type of wildlife 304 within the predetermined area. For example, in one embodiment, the image processing module 31 may be configured to detect the presence of deer within the predetermined area. The image processing module 31 may process the first image 302 and the second image 306 and determine that deer are present. The image processing module 31 may provide a signal indicating the specific type of wildlife has been detected. The environmental camera 4 may save the triggered environmental data 10 associated with the captured image only when the image processing module 31 determines the presence of the specific type of wildlife.

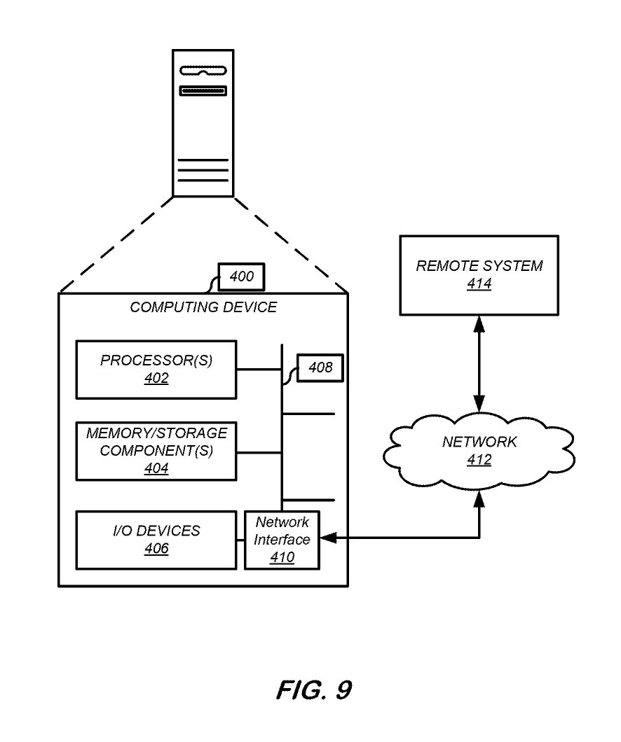

FIG. 9 shows one embodiment of a computing device 400 which can be used in one embodiment of the system and method for predicting animal activity. For the sake of clarity, the computing device 400 is shown and described here in the context of a single computing device. It is to be appreciated and understood, however, that any number of suitably configured computing devices can be used to implement any of the described embodiments. For example, in at least some implementation, multiple communicatively linked computing devices are used. One or more of these devices can be communicatively linked in any suitable way such as via one or more networks (LANs), one or more wide area networks (WANs) or any combination thereof.

In this example, the computing device 400 comprises one or more processor circuits or processing units 402, on or more memory circuits and/or storage circuit component(s) 404 and one or more input/output (I/O) circuit devices 406. Additionally, the computing device 400 comprises a bus 408 that allows the various circuit components and devices to communicate with one another. The bus 408 represents one or more of any of several types of bus structures, including a memory bus or local bus using any of a variety of bus architectures. The bus 3008 may comprise wired and/or wireless buses.

The processing unit 402 may be responsible for executing various software programs such as system programs, applications programs, and/or module to provide computing and processing operations for the computing device 400. The processing unit 402 may be responsible for performing various voice and data communications operations for the computing device 400 such as transmitting and receiving voice and data information over one or more wired or wireless communication channels. Although the processing unit 402 of the computing device 400 includes single processor architecture as shown, it may be appreciated that the computing device 400 may use any suitable processor architecture and/or any suitable number of processors in accordance with the described embodiments. In one embodiment, the processing unit 400 may be implemented using a single integrated processor.

The processing unit 402 may be implemented as a host central processing unit (CPU) using any suitable processor circuit or logic device (circuit), such as a as a general purpose processor. The processing unit 402 also may be implemented as a chip multiprocessor (CMP), dedicated processor, embedded processor, media processor, input/output (I/O) processor, co-processor, microprocessor, controller, microcontroller, application specific integrated circuit (ASIC), field programmable gate array (FPGA), programmable logic device (PLD), or other processing device in accordance with the described embodiments.

As shown, the processing unit 402 may be coupled to the memory and/or storage component(s) 404 through the bus 408. The memory bus 408 may comprise any suitable interface and/or bus architecture for allowing the processing unit 402 to access the memory and/or storage component(s) 404. Although the memory and/or storage component(s) 404 may be shown as being separate from the processing unit 402 for purposes of illustration, it is worthy to note that in various embodiments some portion or the entire memory and/or storage component(s) 404 may be included on the same integrated circuit as the processing unit 402. Alternatively, some portion or the entire memory and/or storage component(s) 404 may be disposed on an integrated circuit or other medium (e.g., hard disk drive) external to the integrated circuit of the processing unit 402. In various embodiments, the computing device 400 may comprise an expansion slot to support a multimedia and/or memory card, for example.

The memory and/or storage component(s) 404 represent one or more computer-readable media. The memory and/or storage component(s) 404 may be implemented using any computer-readable media capable of storing data such as volatile or non-volatile memory, removable or non-removable memory, erasable or non-erasable memory, writeable or re-writeable memory, and so forth. The memory and/or storage component(s) 404 may comprise volatile media (e.g., random access memory (RAM)) and/or nonvolatile media (e.g., read only memory (ROM), Flash memory, optical disks, magnetic disks and the like). The memory and/or storage component(s) 404 may comprise fixed media (e.g., RAM, ROM, a fixed hard drive, etc.) as well as removable media (e.g., a Flash memory drive, a removable hard drive, an optical disk, etc.). Examples of computer-readable storage media may include, without limitation, RAM, dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

The one or more I/O devices 406 allow a user to enter commands and information to the computing device 400, and also allow information to be presented to the user and/or other components or devices. Examples of input devices include a keyboard, a cursor control device (e.g., a mouse), a microphone, a scanner and the like. Examples of output devices include a display device (e.g., a monitor or projector, speakers, a printer, a network card, etc.). The computing device 400 may comprise an alphanumeric keypad coupled to the processing unit 402. The keypad may comprise, for example, a QWERTY key layout and an integrated number dial pad. The computing device 400 may comprise a display coupled to the processing unit 402. The display may comprise any suitable visual interface for displaying content to a user of the computing device 400. In one embodiment, for example, the display may be implemented by a liquid crystal display (LCD) such as a touch-sensitive color (e.g., 76-bit color) thin-film transistor (TFT) LCD screen. The touch-sensitive LCD may be used with a stylus and/or a handwriting recognizer program.

The processing unit 402 may be arranged to provide processing or computing resources to the computing device 400. For example, the processing unit 402 may be responsible for executing various software programs including system programs such as operating system (OS) and application programs. System programs generally may assist in the running of the computing device 400 and may be directly responsible for controlling, integrating, and managing the individual hardware components of the computer system. The OS may be implemented, for example, as a Microsoft® Windows OS, Symbian OS™, Embedix OS, Linux OS, Binary Run-time Environment for Wireless (BREW) OS, JavaOS, Android OS, Apple OS or other suitable OS in accordance with the described embodiments. The computing device 3000 may comprise other system programs such as device drivers, programming tools, utility programs, software libraries, application programming interfaces (APIs), and so forth.

The computer 400 also includes a network interface 410 coupled to the bus 408. The network interface 410 provides a two-way data communication coupling to a local network 412. For example, the network interface 410 may be a digital subscriber line (DSL) modem, satellite dish, an integrated services digital network (ISDN) card or other data communication connection to a corresponding type of telephone line. As another example, the communication interface 410 may be a local area network (LAN) card effecting a data communication connection to a compatible LAN. Wireless communication means such as internal or external wireless modems may also be implemented.

In any such implementation, the network interface 410 sends and receives electrical, electromagnetic or optical signals that carry digital data streams representing various types of information, such as the selection of goods to be purchased, the information for payment of the purchase, or the address for delivery of the goods. The network interface 410 typically provides data communication through one or more networks to other data devices. For example, the network interface 410 may effect a connection through the local network to an Internet Host Provider (ISP) or to data equipment operated by an ISP. The ISP in turn provides data communication services through the internet (or other packet-based wide area network). The local network and the internet both use electrical, electromagnetic or optical signals that carry digital data streams. The signals through the various networks and the signals on the network interface 410, which carry the digital data to and from the computer system 400, are exemplary forms of carrier waves transporting the information.

The computer 400 can send messages and receive data, including program code, through the network(s) and the network interface 410. In the Internet example, a server might transmit a requested code for an application program through the internet, the ISP, the local network (the network 412) and the network interface 410. In accordance with the invention, one such downloaded application provides for the identification and analysis of a prospect pool and analysis of marketing metrics. The received code may be executed by processor 404 as it is received, and/or stored in storage device 410, or other non-volatile storage for later execution. In this manner, computer 400 may obtain application code in the form of a carrier wave.

Various embodiments may be described herein in the general context of computer executable instructions, such as software, program modules, and/or engines being executed by a computer. Generally, software, program modules, and/or engines include any software element arranged to perform particular operations or implement particular abstract data types. Software, program modules, and/or engines can include routines, programs, objects, components, data structures and the like that perform particular tasks or implement particular abstract data types. An implementation of the software, program modules, and/or engines components and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, program modules, and/or engines may be located in both local and remote computer storage media including memory storage devices.

Although some embodiments may be illustrated and described as comprising functional components, software, engines, and/or modules performing various operations, it can be appreciated that such components or modules may be implemented by one or more hardware components, software components, and/or combination thereof. The functional components, software, engines, and/or modules may be implemented, for example, by logic (e.g., instructions, data, and/or code) to be executed by a logic device (e.g., processor). Such logic may be stored internally or externally to a logic device on one or more types of computer-readable storage media. In other embodiments, the functional components such as software, engines, and/or modules may be implemented by hardware elements that may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software, engines, and/or modules may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some cases, various embodiments may be implemented as an article of manufacture. The article of manufacture may include a computer readable storage medium arranged to store logic, instructions and/or data for performing various operations of one or more embodiments. In various embodiments, for example, the article of manufacture may comprise a magnetic disk, optical disk, flash memory or firmware containing computer program instructions suitable for execution by a general purpose processor or application specific processor. The embodiments, however, are not limited in this context.

The functions of the various functional elements, logical blocks, modules, and circuits elements described in connection with the embodiments disclosed herein may be implemented in the general context of computer executable instructions, such as software, control modules, logic, and/or logic modules executed by the processing unit. Generally, software, control modules, logic, and/or logic modules comprise any software element arranged to perform particular operations. Software, control modules, logic, and/or logic modules can comprise routines, programs, objects, components, data structures and the like that perform particular tasks or implement particular abstract data types. An implementation of the software, control modules, logic, and/or logic modules and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, control modules, logic, and/or logic modules may be located in both local and remote computer storage media including memory storage devices.

Additionally, it is to be appreciated that the embodiments described herein illustrate example implementations, and that the functional elements, logical blocks, modules, and circuits elements may be implemented in various other ways which are consistent with the described embodiments. Furthermore, the operations performed by such functional elements, logical blocks, modules, and circuits elements may be combined and/or separated for a given implementation and may be performed by a greater number or fewer number of components or modules. As will be apparent to those of skill in the art upon reading the present disclosure, each of the individual embodiments described and illustrated herein has discrete components and features which may be readily separated from or combined with the features of any of the other several aspects without departing from the scope of the present disclosure. Any recited method can be carried out in the order of events recited or in any other order which is logically possible.

It is worthy to note that any reference to “one embodiment” or “an embodiment” means that a particular feature, structure, or characteristic described in connection with the embodiment is comprised in at least one embodiment. The appearances of the phrase “in one embodiment” or “in one aspect” in the specification are not necessarily all referring to the same embodiment.

Unless specifically stated otherwise, it may be appreciated that terms such as “processing,” “computing,” “calculating,” “determining,” or the like, refer to the action and/or processes of a computer or computing system, or similar electronic computing device, such as a general purpose processor, a DSP, ASIC, FPGA or other programmable logic device, discrete gate or transistor logic, discrete hardware components, or any combination thereof designed to perform the functions described herein that manipulates and/or transforms data represented as physical quantities (e.g., electronic) within registers and/or memories into other data similarly represented as physical quantities within the memories, registers or other such information storage, transmission or display devices.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, application program interface (API), exchanging messages, and so forth.

What is claimed is:

1. A system for predicting animal activity comprising:
an imaging device configured to capture an image of a predetermined area;
a environmental data sensor configured to detect one or more environmental factors within the predetermined area, wherein the environmental data sensor is configured to collect random environmental data at least once during a predetermined period;
a trigger, wherein, when the trigger is activated, the imaging device captures the image of the predetermined area and the environmental data sensor collects triggered environmental data, and wherein the trigger is responsive to the presence of wildlife within the predetermined area; and
a memory unit, wherein the memory unit is configured to store the random environmental data, the image of the predetermined area, and the triggered environmental data, wherein a statistical probability algorithm is determined based on the random environmental data and the triggered environmental data, wherein the random environmental data and the triggered environmental data are provided to a statistical regression, and wherein the statistical probability algorithm calculates a predicted activity index.

2. The system of claim 1, wherein the statistical regression comprises a linear regression.

3. The system of claim 2, wherein the linear regression calculates the statistical probability algorithm to determine a predictive activity index in accordance with the following relationship:
PAI=Xa+Yb+Zc . . .
wherein, PAI is the predicted activity index, X, Y, and Z are the one or more environmental factors, and a, b, and c are weighting factors determined by the statistical probability algorithm.

4. The system of claim 1, wherein the statistical regression comprises a multivariate regression.

5. The system of claim 1, comprising a global positioning unit configured to determine a position of the environmental data sensor, wherein the position of the environmental data sensor is associated with the statistical probability algorithm and the predicted activity index.

6. The system of claim 1, wherein the environmental data sensor comprises at least one sensor selected from the group consisting of: a temperature sensor, a wind speed sensor, a wind direction sensor, a dew point sensor, a humidity sensor, and a barometric pressure sensor.

7. The system of claim 1, comprising a processor configured to execute the statistical regression, wherein the statistical probability algorithm determined by the regression is stored in the memory unit.

8. The system of claim 1, comprising a wireless communication module in signal communication with the memory unit, wherein the wireless communication module is configured to transmit the image of the predetermined area, the random weather data, and the triggered weather data to a remote device, and wherein the remote device is configured to determine the statistical probability algorithm.

9. The system of claim 1, comprising an image processing unit configured to detect the presence of a specific type of wildlife within the image of the predetermined area, wherein the memory unit is configured to store the triggered environmental data only when the specific type of wildlife is detected within the image of the predetermined area.

10. A method for predicting animal activity, the method comprising:
receiving, by a processor, random environmental data, wherein the random environmental data comprises at least one environmental factor measured within a predetermined area;
receiving, by the processor, triggered environmental data, wherein the triggered environmental data comprises the at least one environmental factor;
receiving, by the processor, an image of the predetermined area provided by an imaging device configured to image the predetermined area; and
calculating, by a statistical regression implemented by the processor, a statistical probability algorithm for the predetermined area, wherein the random environmental data and the triggered environmental data are provided as inputs to the statistical regression, and wherein the statistical probability algorithm calculates a predicted activity index.

11. The method of claim 10, comprising receiving, by the processor, the triggered environmental data from a user.

12. The method of claim 10, comprising receiving, by the processor, the triggered environmental data from an environmental data sensor, wherein the environmental data sensor collects the triggered environmental data in response to a trigger signal.

13. The method of claim 10, comprising storing, by a memory unit, the statistical probability model.

14. The method of claim 13, comprising:
receiving, by the processor, location data corresponding to the location of the predetermined area;
associating, by the processor, the location of the predetermined area with the statistical probability model of the predetermined area; and
storing, by the memory unit, the associated location with the statistical probability model.

15. The method of claim 10, comprising modifying, by the processor, the statistical probability algorithm based on the triggered environmental data.

16. A server configured to calculate a predicted activity index of wildlife within a predetermined area, the server comprising:
a processor; and
a memory unit configured to store a plurality of instruction, wherein when the plurality of instructions are loaded by the processor, the processor is configured to:
receive random environmental data, wherein the random environmental data comprises at least one environmental factor measured within the predetermined area;
receive triggered environmental data, wherein the triggered environmental data comprises the at least one environmental factor;
receive an image of the predetermined area;
determine a statistical probability algorithm using a statistical regression, wherein the random environmental data and the triggered environmental data are provided as inputs to the statistical regression, and wherein the statistical probability algorithm calculates a predicted activity index.

17. The server of claim 16, wherein the processor is configured to:
store the statistical probability algorithm in the memory unit.

18. The server of claim 16, wherein the processor is configured to
receive user environmental data, wherein the user environmental data comprises the at least one environmental factor; and
calculate the predicted activity index based on the user environmental data and the statistical probability algorithm.

19. The server of claim 16, wherein the processor is configured to:
receive global positioning data corresponding to the predetermined area; and
associate the global positioning data with the statistical probability model.

20. The server of claim 16, wherein the processor is configured to:
provide the statistical probability model to a remote device, wherein the remote device is configured to calculate the predicted activity index based on the provided statistical probability model.
